(19) United States
(12) Patent Application Publication
(10) Pub. No.: US 2013/0054268 A1
(43) Pub. Date: Feb. 28, 2013

(54) SYSTEMS AND METHODS FOR ABSTRACTING IMAGE AND VIDEO DATA

(71) Applicants: David James Beymer, San Jose, CA (US); Varun Bhagwan, San Jose, CA (US); Tyrone W. A. Grandison, San Jose, CA (US); Daniel Frederick Gruhl, San Jose, CA (US)

(72) Inventors: David James Beymer, San Jose, CA (US); Varun Bhagwan, San Jose, CA (US); Tyrone W. A. Grandison, San Jose, CA (US); Daniel Frederick Gruhl, San Jose, CA (US)

(73) Assignee: International Business Machines Corporation, Armonk, NY (US)

(21) Appl. No.: 13/218,765

(22) Filed: Aug. 26, 2011

(51) Int. Cl. G06Q 50/00

(52) U.S. Cl. 705/3; 705/2

(57) ABSTRACT

Systems and methods for removing or suppressing information in images and video frames is described herein. In particular, systems and methods provide for removing information from images capable of identifying individuals related to the image. For example, embodiments provide for the removal of protected health information (PHI) from source images, including medical images, video frames, and documents converted to images or video frames. In addition, embodiments operate on actual images and video frames as opposed to data extracted from such sources. In particular, embodiments provide for the creation of a PHI filter for an individual of interest comprised of identifying information. Images are filtered using the PHI filter and information potentially identifying the individual of interest is located and removed from the image.

### BACKGROUND

As healthcare systems and institutions embrace computerization, there are fundamental issues that will play pivotal roles in the use and effectiveness of the delivered systems. A first issue arises because a majority of healthcare data for the healthcare institution's members is now multi-modal data, for example, images and audio, or text embedded within visual data. Some estimates indicate that over 80% of healthcare data may now be multi-modal. A second issue involves the inherent sensitivity of information created in the healthcare and related fields, such as patient care and medical research records from the healthcare institution. In addition, the cost implications of potential and actual information exposure from the healthcare institution may be significant. As such, protected health information (PHI) must be treated with the utmost care by authorized holders of such information in the healthcare industry, with a focus by such institutions on data security and maintaining the privacy of patients and sources of research material.

Certain government and industry regulations compel organizations dealing with PHI to handle the data according to proscribed guidelines. The Health Insurance Portability and Accountability Act of 1996 (HIPAA) is the principal law affecting the use and dissemination of PHI. HIPAA limits how covered entities may use PHI internally and disclose PHI externally. Covered entities include healthcare providers and certain health plans. HIPAA regulations may indirectly cover those working with, but not directly affiliated with, a covered entity, for example, if a covered entity unknowingly supplies data to the non-covered individual.

According to HIPAA, PHI involves individually identifiable information involving a health condition, healthcare, or payment for healthcare if the information was either created or received by a covered entity, including PHI created during research. A set of eighteen “HIPAA identifiers” are considered PHI that may identify an individual or others related to that individual, and must be removed from covered medical information sources. HIPAA identifiers include names, dates, certain geographical subdivisions, phone numbers, Social Security numbers, biometric identifiers, and Internet Protocol (IP) address numbers. As such, methods must be utilized by healthcare institutions and other covered entities to remove or suppress PHI from the myriad forms of health information used by such entities and individuals covered under HIPAA.

### BRIEF SUMMARY

The subject matter described herein generally relates to image and video data. In particular, certain subject matter presented herein provides systems and methods for removing, suppressing or otherwise abstracting certain information contained in image and video data. For example, embodiments provide for identifying and removing PHI from medical images, including, but not limited to, x-rays and MRI images.

In summary, one aspect provides a system comprising: a system memory; at least one image processing module communicatively coupled to the system memory, wherein the at least one image processing module is adapted to: generate at least one protected health information filter comprised of at least one element of protected health information; and process at least one source image using the at least one protected health information filter, wherein processing the at least one source image comprises abstracting instances of the at least one element of protected health information detected in the at least one source image.

Another aspect provides a method comprising: generating at least one protected health information filter comprised of at least one element of protected health information; processing at least one source image using the at least one protected health information filter, wherein processing the at least one source image comprises abstracting instances of the at least one element of protected health information detected in the at least one source image.

A further aspect provides a computer program product comprising: a computer readable storage medium having computer readable program code embodied therewith, the computer readable program code comprising: computer readable program code configured to generate at least one protected health information filter comprised of at least one element of protected health information; computer readable program code configured to process at least one source image using the at least one protected health information filter, wherein processing the at least one source image comprises abstracting instances of the at least one element of protected health information detected in the at least one source image.

The foregoing is a summary and thus may contain simplifications, generalizations, and omissions of detail; consequently, those skilled in the art will appreciate that the summary is illustrative only and is not intended to be in any way limiting. For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of PHI filtering.

FIG. 2 illustrates an example of PHI template generation.

FIG. 3 illustrates an example of filtering source images and video frames using a PHI filter bank.

FIG. 4 illustrates an example computer system.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the claims, but is merely representative of certain example embodiments.

Reference throughout this specification to an “embodiment” or “embodiment(s)” means that a particular feature, structure, or characteristic described in connection with the embodiment is included in at least one embodiment. Thus, the appearances of “embodiment” or “embodiment(s)” in various places throughout this specification are not necessarily all referring to the same embodiment.

Furthermore, the described features, structures, or characteristics may be combined in any suitable manner in one or more embodiments. In the following description, numerous specific details are provided to give a thorough understanding of example embodiments. One skilled in the relevant art will recognize, however, that aspects can be practiced without one or more of the specific details, or with other methods, components, materials, et cetera. In other instances, well-known structures, materials, or operations are not shown or described in detail to avoid prolixity.

Electronic health records are increasingly comprised of digital image data. From x-rays to echocardiograms, digital image data forms an important part of the total patient history. Unfortunately, they also introduce an extremely difficult problem for entities concerned with PHI removal, as such images often include identifying information, such as a patient's name or medical record number (MRN), embedded in the image.

Certain individuals, such as clinical care providers, appreciate digital image data embedded in health records, as they provide confirmation that a given study is of the patient they are treating. However, there is an increasing emphasis on comparative effectiveness and personalized medicine that is resulting in more clinicians considering specifics of how well treatments have worked on previous similar cases. As a result, an increased need has arisen for versions of health information records unaccompanied by PHI. These “clean” versions of health records would provide information concerning treatments and outcomes, but would not provide information that could potentially identify a patient.

According to current technology, the dominant information processing and PHI cleaning methods are tuned to operate on relational and hierarchical systems with structured information. In order to apply current PHI cleaning methods to the healthcare industry, auxiliary (i.e., structured) information is typically extracted from the healthcare data and processing operations are then performed on this extracted information. Certain analyses comparing the original health data and the extracted data indicate that it is not possible to detect and extract all of the information necessary to have all of the semantic information fully represent the original health data. Accordingly, the results of native processing of image data, and multi-modal data in particular, are superior than processing extracted data according to existing technology.

Embodiments provide systems and methods for native detection and abstraction of information using original image data sources. Embodiments may use PHI characteristics, including, but not limited to, PHI phrases and fonts, to detect PHI images within an image source. Non-limiting examples of PHI include names, addresses, dates, MRN, Social Security numbers, and combinations thereof. Image sources may include any image or video capable of being examined for the removal or abstraction of PHI, including, but not limited to, x-rays, CT images, MRI images, ultrasound images, PET images, SPECT and ECT images, documents converted to images, and videos of medical procedures, research, or subject interviews. In addition, embodiments may use source images comprised of any applicable file format, including, but not limited to, .jpg, .bmp, .gif, .tif, png, .wav, .avi, .mp4, .flv, .pdf, DICOM, and scanner/PACS system formats. In addition, embodiments use known PHI information to generate templates modeling how PHI appears in image source data. Embodiments use the templates to locate PHI in images and videos being examined for PHI.

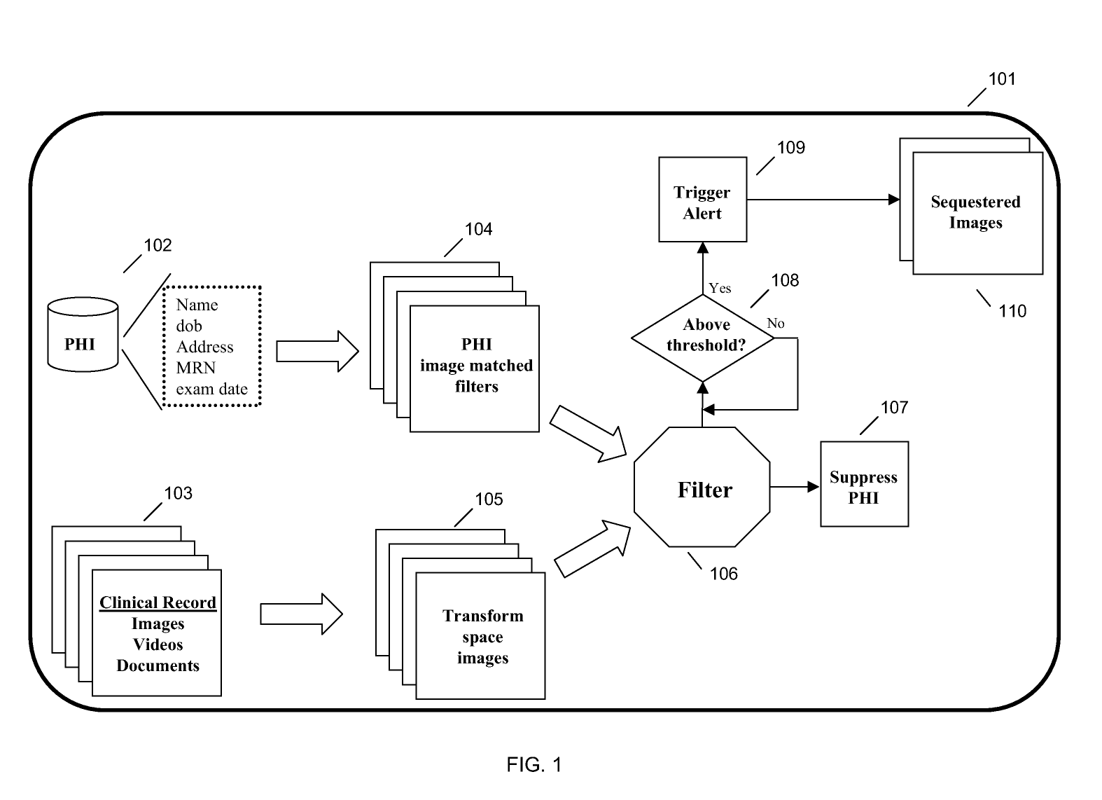

Referring to FIG. 1, therein is depicted a diagram of PHI filtering according to an embodiment. A computing system 101 has access to PHI and PHI formats of interest 102 and clinical record images and documents 103. Embodiments provide that the computing system 101 may be comprised of workstations, servers, networks of computing devices or combinations thereof. The computing system 101 renders the PHI and PHI formats of interest 101 as image snippets and transforms them to create PHI image matched filters 104. In the embodiment depicted in FIG. 1, identifying PHI and PHI formats 102 comprises identifying PHI phrases as well as identifying fonts likely to occur in the source images. Identifying fonts includes the face and scale of the fonts. In addition, a lower precision with a higher recall may be achieved by blurring the fonts. The subject images from the clinical record 103 are transformed and the transform space images stored 105. The images are filtered for PHI 106. According to the embodiment depicted in FIG. 1, checking for PHI may include multiplying the transform of each image snippet 104 by each source image or video frame 103. Due to the intensity of image processing, checking for PHI according to such an embodiment would benefit from the use of a Graphical Processing Unit (GPU). If an image has PHI, the PHI is abstracted by, inter alia, covering, removing, blurring or otherwise suppressing the section of the image containing the PHI 107.

If any point in the set of filtered images is above a threshold value 108, an alert is triggered 109 and the image sequestered 110. The sequestered image may be subjected to further scrutiny, not shown in FIG. 1, including further filtering or user verification. For example, embodiments provide for applying pre-computed matched filters to the medical image portion of the clinical record to “post scan” the images for potential PHI “data leaks.” Such leaks may then be brought to the attention of certain system users, such as a subject matter expert who can address the problem before an image portion of the medical record is released for research use.

Embodiments provide for using prior patient PHI information to aid in detection and cleaning of images and video frames included in a patient's records. For example, embodiments use known PHI, such as a patient's name or MRN, to create a matched filter that matches the expected appearance of the patient's name against image information included in source images and video frames. Embodiments provide that peaks in the filter output may correspond with PHI matches. As such, those images or video frames may be flagged as PHI detections and potentially sent to a PHI cleaning stage.

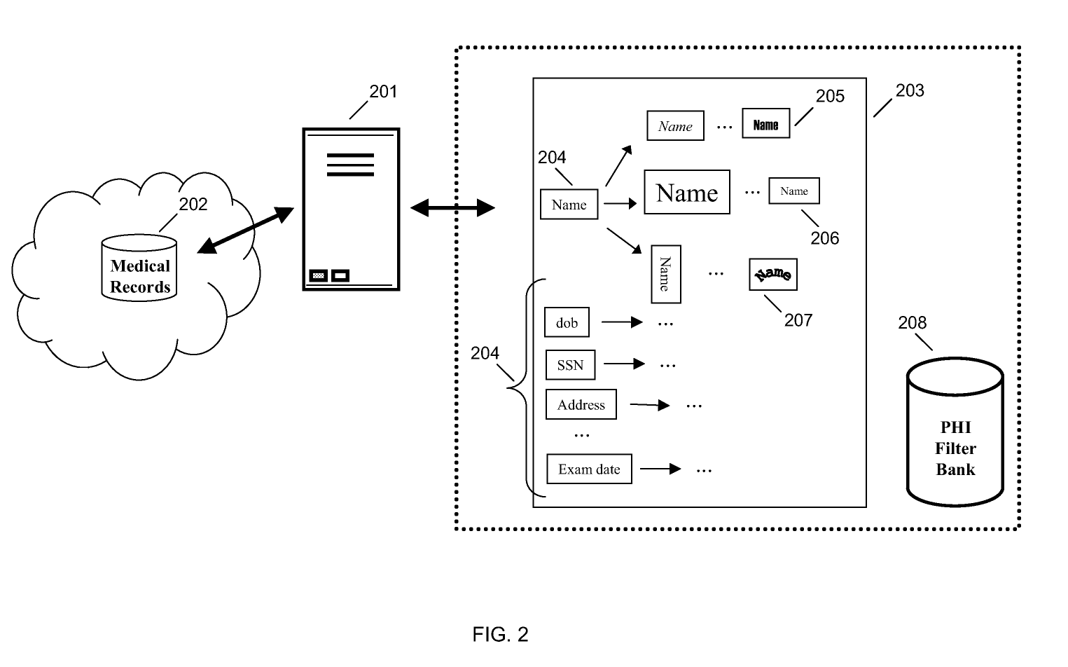

Referring to FIG. 2, therein is depicted PHI template generation according to an embodiment. A PHI filtering computer system 201 accesses a patient's medical records 202. A filter bank 203 for the patient is created based on the medical records 202. The filter bank 203 is comprised of template elements 204 for each PHI field that will be examined and varying appearances thereof. According to the embodiment depicted in FIG. 2, varying PHI appearances may include examining fonts 205, scale 206, and rotation 207. Fonts 205 may include generating serif and san serif versions of subject fonts. Scale 206 may include covering expected scales of PHI in source images, plus additional nearby scales to maintain a margin of safety. Rotation 207 allows for the handling of skewed or rotated images and elements within images. The filter bank 203 is saved in a database 208 located accessible to the PHI filtering computer system 201.

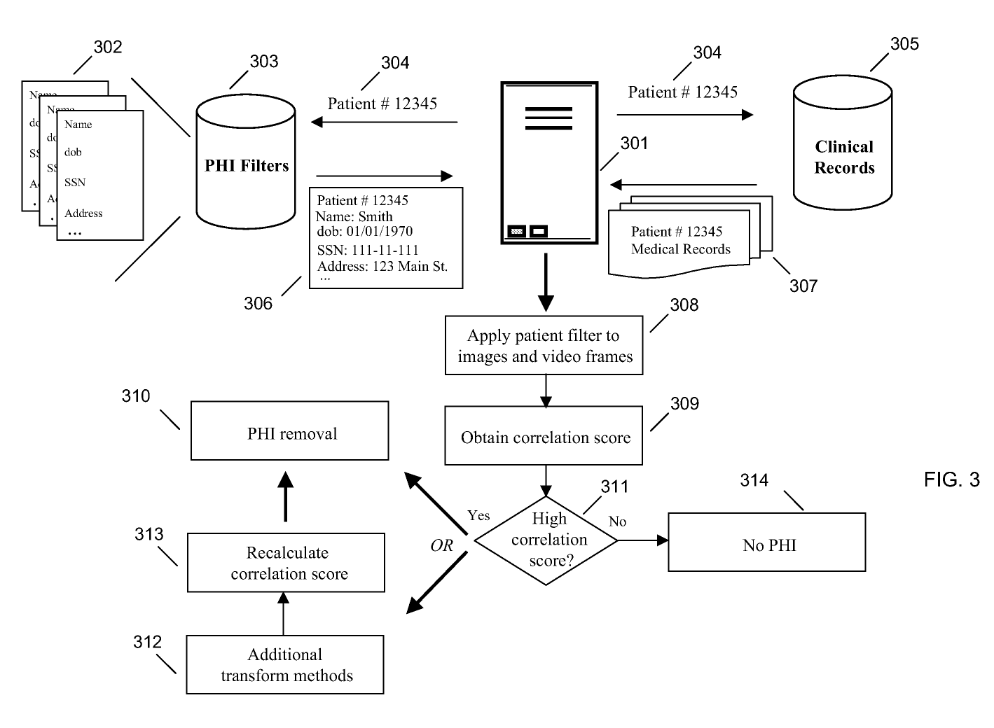

FIG. 3 illustrates filtering source images and video frames using a filter bank according to an embodiment. Filters 302 are stored in a filter database 303. The computer system 301 accesses the filter for a particular subject 304 and the source images and video frames 305. In the non-limiting example depicted in FIG. 3, the subject is a patient and the images and video frames are obtained from the patient's clinical record. The subject filter 306 is applied to each image and video frame 307 using a correlation technique 308 according to embodiments and a correlation score is calculated 309. Non-limiting examples of correlation techniques include standard correlation or normal correlation, and a Fast Fourier Transform approach, which may implement correlation quickly. Image locations with a high correlation score 311, for example, compared to a predetermined threshold, may be subject to PHI information removal 310. Images locations that do not exhibit a high correlation score 311 are indicative of image locations with no PHI 314.

Embodiments provide that areas of detected PHI may consist of the PHI field plus a bounding box in the image or video frame where the match occurred. Information removal 310 may be performed by any applicable method capable of abstracting image information. A non-limiting example involves selectively applying a cleaning filter within the PHI field bounding box. Cleaning filters according to embodiments include, but are not limited to, Gaussian blur with large sigma, or setting each pixel to a constant value.

According to certain embodiments, image locations with a high correlation score 311 may be examined further by applying additional transform methods 312 before PHI removal 310 in order to, inter alia, improve the registration with the matching template. Further transform methods 312 may include, but are not limited to, affine or projective transform methods. Responsive to the image patch and subject filter 304 being brought into a closer registration 312, the correlation score may be recalculated 313, the match re-evaluated using a more conservative threshold 313, and the image locations subjected to PHI removal 310. These embodiments provide for more precise PHI removal. As a non-limiting example, if blurring the PHI, the blurring effect may be applied to an exact location (e.g., patient name) rather than to a larger bounded area determined to contain PHI.

Embodiments provide for creating a PHI filter or template for each individual based on their particular PHI. For example, embodiments may generate a template for each medical patient based on information in each patients' medical records, including the patient's name, address, date of birth, facial image, and dates of treatment. In addition, embodiments use known information to generate templates of how that information may appear in image and video data. Embodiments use the templates to create filters specific for a particular subject, such as a hospital patient.

Although the description provided herein relies on examples involving PHI and medical records, embodiments are not so limited. Embodiments may be directed toward any type of applicable information in any type of applicable image or video. For example, templates may be created for removing a specific set of words, company logos, trademarks, or other such unwanted textual or visual artifacts from a series of images or videos. In addition, images and videos may be derived from any applicable source, including non-images and video frames converted into image and video forms. For example, a text file may be converted through known methods into an image file and used as an image or incorporated into a video file. Accordingly, embodiments are not limited to PHI data and medical images, nor are embodiments limited to files originally created as images or video frames.

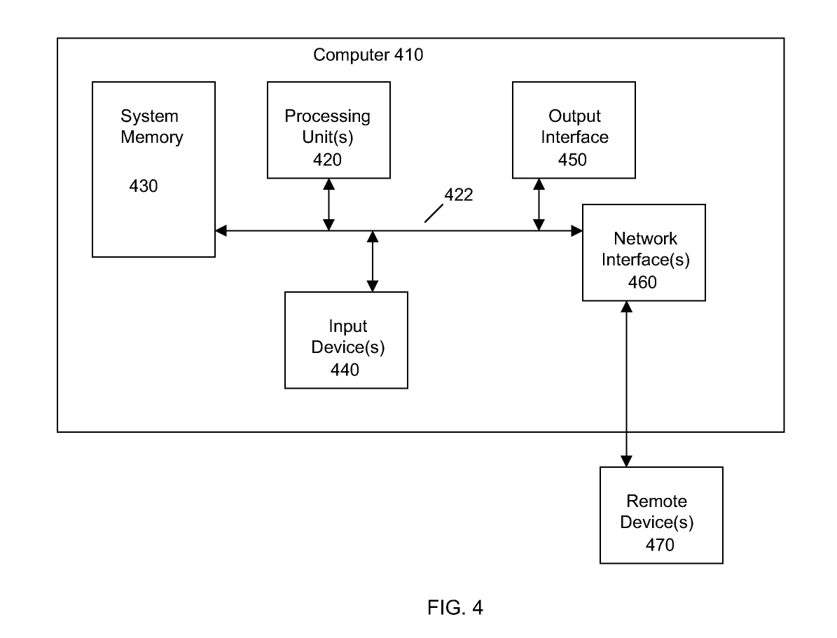

Referring to FIG. 4, it will be readily understood that embodiments may be implemented using any of a wide variety of devices or combinations of devices. An example device that may be used in implementing one or more embodiments includes a computing device in the form of a computer 410. In this regard, the computer 410 may execute program instructions; generate at least one information filter comprised of at least one information element; and process at least one source image using the at least one information filter, wherein processing the at least one source image comprises abstracting instances of the at least one information element detected in the at least one source image; and other functionality of the embodiments, as described herein.

Components of computer 410 may include, but are not limited to, processing units 420, a system memory 430, and a system bus 422 that couples various system components including the system memory 430 to the processing unit 420. Computer 410 may include or have access to a variety of computer readable media. The system memory 430 may include computer readable storage media in the form of volatile and/or nonvolatile memory such as read only memory (ROM) and/or random access memory (RAM). By way of example, and not limitation, system memory 430 may also include an operating system, application programs, other program modules, and program data.

A user can interface with (for example, enter commands and information) the computer 410 through input devices 440. A monitor or other type of device can also be connected to the system bus 422 via an interface, such as an output interface 450. In addition to a monitor, computers may also include other peripheral output devices. The computer 410 may operate in a networked or distributed environment using logical connections to one or more other remote computers or databases. In addition, Remote devices 470 may communicate with the computer 410 through certain network interfaces 460. The logical connections may include a network, such as a local area network (LAN) or a wide area network (WAN), but may also include other networks/buses.

It should be noted as well that certain embodiments may be implemented as a system, method or computer program product. Accordingly, aspects of the invention may take the form of an entirely hardware embodiment, an entirely software embodiment (including firmware, resident software, micro-code, et cetera) or an embodiment combining software and hardware aspects that may all generally be referred to herein as a “circuit,” “module” or “system.” In addition, circuits, modules, and systems may be “adapted” or “configured” to perform a specific set of tasks. Such adaptation or configuration may be purely hardware, through software, or a combination of both. Furthermore, aspects of the invention may take the form of a computer program product embodied in one or more computer readable medium(s) having computer readable program code embodied therewith.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, et cetera, or any suitable combination of the foregoing.

Computer program code for carrying out operations for aspects of the invention may be written in any combination of one or more programming languages, including an object oriented programming language such as Java™, Smalltalk, C++ or the like and conventional procedural programming languages, such as the “C” programming language or similar programming languages. The program code may execute entirely on the user's computer (device), partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the invention are described herein with reference to flowchart illustrations and/or block diagrams of methods, apparatuses (systems) and computer program products according to example embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Although illustrated example embodiments have been described herein with reference to the accompanying drawings, it is to be understood that embodiments are not limited to those precise example embodiments, and that various other changes and modifications may be affected therein by one skilled in the art without departing from the scope or spirit of the disclosure.

What is claimed is:

1. A system comprising:
a system memory;
at least one image processing module communicatively coupled to the system memory, wherein the at least one image processing module is adapted to:
generate at least one protected health information filter comprised of at least one element of protected health information; and
process at least one source image using the at least one protected health information filter, wherein processing the at least one source image comprises abstracting instances of the at least one element of protected health information detected in the at least one source image.

2. The system according to claim 1, further comprising:
at least one subject information source; and
at least one protected health information template;
wherein the at least one element of protected health information is selected from the at least one subject information source based on the at least one protected health information template.

3. The system according to claim 1, wherein the at least one protected health information template is comprised of protected health information determined to have a potential to occur in the at least one source image.

4. The system according to claim 2, wherein the at least one subject information source comprises at least one source of protected health information for a patient.

5. The system according to claim 1, wherein the at least one source image comprises a medical image.

6. The system according to claim 1, wherein the at least one source image comprises a video frame.

7. The system according to claim 1, wherein the at least one protected health information template further comprises:
at least one field; and
at least one appearance for each of the at least one field.

8. The system according to claim 7, wherein the at least one appearance comprises font, scale, and rotation.

9. The system according to claim 1, wherein processing the at least one source image comprises applying the at least one protected health information filter to the at least one source image using Fast Fourier Transform.

10. The system according to claim 1, wherein abstracting instances of the at least one element of protected health information detected in the at least one source image comprises removing a section of the at least one source image containing the at least one element of protected health information.

11. A method comprising:
generating at least one protected health information filter comprised of at least one element of protected health information;
processing at least one source image using the at least one protected health information filter, wherein processing the at least one source image comprises abstracting instances of the at least one element of protected health information detected in the at least one source image.

12. The method according to claim 11, further comprising:
accessing at least one subject information source; and
configuring at least one protected health information template;
wherein the at least one element of protected health information is selected from the at least one subject information source based on the at least one protected health information template.

13. The method according to claim 11, wherein the at least one protected health information template is comprised of protected health information determined to have a potential to occur in the at least one source image.

14. The method according to claim 12, wherein the at least one subject information source comprises at least one source of protected health information for a patient.

15. The method according to claim 11, wherein the at least one source image comprises a medical image.

16. The method according to claim 11, wherein the at least one source image comprises a video frame.

17. The method according to claim 11, wherein the at least one protected health information template further comprises:
at least one field; and
at least one appearance for each of the at least one field, wherein the at least one appearance comprises font, scale, and rotation.

18. The method according to claim 11, wherein processing the at least one source image comprises applying the at least one protected health information filter to the at least one source image using Fast Fourier Transform.

19. The method according to claim 11, wherein abstracting instances of the at least one element of protected health information detected in the at least one source image comprises removing a section of the at least one source image containing the at least one element of protected health information.

20. A computer program product comprising:
a computer readable storage medium having computer readable program code embodied therewith, the computer readable program code comprising:
computer readable program code configured to generate at least one protected health information filter comprised of at least one element of protected health information;
computer readable program code configured to process at least one source image using the at least one protected health information filter, wherein processing the at least one source image comprises abstracting instances of the at least one element of protected health information detected in the at least one source image.
